(19) United States
(12) Patent Application Publication
(10) Pub. No.: US 2021/0032488 A1
(43) Pub. Date: Feb. 4, 2021

(54) INKJET INK AND INKJET RECORDING SYSTEM

(71) Applicant: KYOCERA Document Solutions Inc., Osaka (JP)

(72) Inventor: Masafumi SAITO, Osaka-shi (JP)

(73) Assignee: KYOCERA Document Solutions Inc., Osaka (JP)

(21) Appl. No.: 16/945,262

(22) Filed: Jul. 31, 2020

(30) Foreign Application Priority Data
Aug. 1, 2019 (JP) 2019-142176

(51) Int. Cl. C09D 11/38; C09D 11/324; B41M 5/00

(52) U.S. Cl. CPC C09D 11/38; B41M 5/0023; C09D 11/324

(57) ABSTRACT

An inkjet ink contains pigment particles, a glycol ether, a sugar alcohol, and water. The sugar alcohol has a melting point of 25° C. or higher. A content percentage of the glycol ether is at least 6.0% by mass and no greater than 40.0% by mass. A content percentage of the sugar alcohol is at least 2.0% by mass and no greater than 10.0% by mass. The content percentage of the glycol ether is greater than the content percentage of the sugar alcohol.

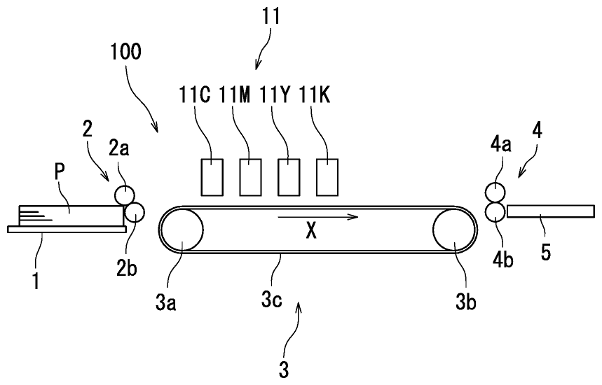

### INCORPORATION BY REFERENCE

The present application claims priority under 35 U.S.C. § 119 to Japanese Patent Application No. 2019-142176, filed on Aug. 1, 2019. The contents of this application are incorporated herein by reference in their entirety.

### BACKGROUND

The present disclosure relates to an inkjet ink and an inkjet recording system.

A demand for energy saving in office equipment is increasing in recent years. In order to accommodate the demand, inkjet recording systems gather a focus in a field of image forming apparatuses. The inkjet recording systems tend to consume less energy than other image forming apparatuses (for example, electrographic image forming apparatuses). In terms of further reducing energy consumption, the inkjet recording systems preferably do not include a post-processing section that dries a recording medium after image formation. Use of an inkjet recording system not including such a post-processing section tends to reduce scratch resistance of a formed image. In view of the foregoing, an inkjet ink with which images excellent in scratch resistance can be formed is desired to be used in such an inkjet recording system not including the post-processing section.

An inkjet ink containing for example a glycol ether that is an organic solvent excellent in permeability to a recording medium (particularly, printing paper) is proposed as an example of the inkjet ink with which images excellent in scratch resistance can be formed. An inkjet ink containing for example a resin that is insoluble in water is proposed as another example of the inkjet ink with which images excellent in scratch resistance can be formed.

### SUMMARY

An inkjet ink according to an aspect of the present disclosure contains pigment particles, a glycol ether, a sugar alcohol, and water. The sugar alcohol has a melting point of 25° C. or higher. A content percentage of the glycol ether is at least 6.0% by mass and no greater than 40.0% by mass. A content percentage of the sugar alcohol is at least 2.0% by mass and no greater than 10.0% by mass. The content percentage of the glycol ether is greater than the content percentage of the sugar alcohol.

An inkjet recording system according to an aspect of the present disclosure includes a recording head and a conveyance section that conveys a recording medium. The recording head ejects the above-described inkjet ink toward the recording medium. The inkjet recording system does not include a post-processing section that dries the recording medium toward which the inkjet ink has been ejected.

### BRIEF DESCRIPTION OF THE DRAWINGS

FIGURE is a side view of an example of an inkjet recording system.

### DETAILED DESCRIPTION

The following describes embodiments of the present disclosure. Note that measurement values for volume median diameter (D₅₀) are values measured using a dynamic light scattering type particle size distribution analyzer (“ZETASIZER NANO ZS”, product of Malvern Panalytical) unless otherwise stated.

In the present description, the term “(meth)acryl” is used as a generic term for both acryl and methacryl.

### First Embodiment: Ink

The following describes an inkjet ink according to a first embodiment of the present disclosure (also referred to below simply as an ink). The ink according to the present embodiment contains pigment particles, a glycol ether, a sugar alcohol, and water. The sugar alcohol has a melting point of 25° C. or higher. A content percentage of the glycol ether is at least 6.0% by mass and no greater than 40.0% by mass. A content percentage of the sugar alcohol is at least 2.0% by mass and no greater than 10.0% by mass. The content percentage of the glycol ether is greater than the content percentage of the sugar alcohol.

Although no particular limitations are placed on use of the ink according to the present embodiment, the ink can be favorably used as an ink for an inkjet recording system not including a later-described post-processing section.

With the above configuration, the ink according to the present embodiment can inhibit occurrence of nozzle clogging and images formed with the ink can be excellent in scratch resistance. Here, being excellent in scratch resistance means that contact of a recording medium directly after image formation with a roller or the like in an image forming apparatus causes no ink peeling and contact of the recording medium after a certain period of time (for example, 24 hours) from the image formation with another recording medium or the like causes no occurrence of ink peeling. The following is presumably a reason why the ink according to the present embodiment can inhibit occurrence of nozzle clogging and images excellent in scratch resistance can be formed with the ink. The ink according to the present embodiment contains a glycol ether. A glycol ether is an organic solvent for ink use that has appropriately high hydrophobicity, and therefore, readily permeates into a recording medium (particularly, printing paper). Furthermore, permeation of water into a recording medium accompanies permeation of a glycol ether into the recording medium. As such, concentration of each solid content (for example, the pigment particles and the sugar alcohol) of the ink according to the present embodiment sharply increases through permeation of the glycol ether and the water into a recording medium after landing of the ink on the recording medium. As a result, the sugar alcohol precipitates on the surface of the recording medium. In particular, the sugar alcohol in the ink according to the present embodiment readily precipitates because the glycol ether and the sugar alcohol each have a specific or higher content percentage and the content percentage of the glycol ether is greater than the content percentage of the sugar alcohol. The precipitated sugar alcohol protects the pigment particles from separation. Since the pigment particles are protected by the precipitated sugar alcohol as above, an image formed with the ink according to the present embodiment is excellent in scratch resistance.

Furthermore, a sugar alcohol is highly soluble in water. The sugar alcohol is accordingly present in the ink according to the present embodiment in a state of being dissolved in the solvent (for example, the water and the glycol ether). Therefore, the ink according to the present embodiment can be ejected favorably as compared to an ink containing an insoluble component such as resin particles. Also, the ink according to the present embodiment can accordingly inhibit occurrence of nozzle clogging.

No particular limitations are placed on a recording medium on which an image is to be formed with the ink according to the present embodiment, but recording paper is preferable. The following describes the ink according to the present embodiment further in detail. As to each of components described below, one type of the component may be used singly or two or more types of the component may be used in combination.

[Pigment Particles]

The pigment particles are present in a dispersed manner for example in the solvent in the ink according to the present embodiment. In terms of improving color density, hue, or stability of the ink according to the present embodiment, the pigment particles have a D₅₀ of preferably at least 30 nm and no greater than 200 nm, and more preferably at least 70 nm and no greater than 130 nm.

Examples of a pigment contained in the pigment particles include yellow pigments, orange pigments, red pigments, blue pigments, violet pigments, and black pigment. Examples of the yellow pigments include C. I. Pigment Yellow (74, 93, 95 109, 110, 120 128, 138, 139, 151, 154, 155, 173, 180, 185, or 193). Examples of the orange pigments include C. I. Pigment Orange (34, 36, 43, 61, 63, or 71). Examples of the red pigments include C. I. Pigment Red (122 or 202). Examples of the blue pigments include C. I. Pigment Blue (15, more specifically 15:3). Examples of the violet pigments include C. I. Pigment Violet (19, 23, or 33). Examples of the black pigments include C.I. Pigment Black (7).

The pigment particles may contain only a pigment. Alternatively, the pigment particles may contain a pigment and a resin. Examples of pigment particles containing a pigment and a resin include pigment particles containing pigment cores containing a pigment and a resin covering surfaces of the pigment cores. Examples of the resin contained in the pigment particles include copolymers of at least one monomer of (meth)acrylic acid alkyl ester, styrene, and vinyl naphthalene and at least one monomer of (meth)acrylic acid and maleic acid.

The resin contained in the pigment particles is preferably a hydrophilic resin that is a resin having low compatibility with a glycol ether. The glycol ether and the water in the ink according to the present embodiment permeate into a recording medium after the ink lands on the recording medium as described above. In a configuration in which the pigment particles contain a hydrophilic resin, when the glycol ether and the water permeate into a recording medium to increase a solid concentration of the ink, the pigment particles tend to remain on the surface of the recording medium. Consequently, images further excellent in scratch resistance can be formed with the ink according to the present embodiment.

In a configuration in which the pigment particles contain a resin, an amount of the resin contained in the pigment particles is for example at least 15 parts by mass and no greater than 40 parts by mass relative to 100 parts by mass of the pigment.

A content percentage of the pigment particles in the ink according to the present embodiment is preferably at least 0.3% by mass and no greater than 5.0% by mass, and more preferably at least 1.0% by mass and no greater than 3.0% by mass. As a result of the content percentage of the pigment particles being set to at least 0.3% by mass, image further excellent in scratch resistance can be formed with the ink according to the present embodiment. Furthermore, as a result of the content percentage of the pigment particles being set to no greater than 5.0% by mass, fluidity of the ink can be increased.

[Glycol Ether]

The glycol ether in the ink according to the present embodiment functions as a solvent together with the water. Here, the glycol ether refers to a compound obtained by substituting one or two hydroxyl groups (preferably, one hydroxyl group) of two hydroxyl groups (—OH groups) that a glycol compound has with a lower alkyl group (for example, an alkyl group having a carbon number of at least 1 and no greater than 6).

Examples of the above glycol compound include alkylene glycol and polyalkylene glycol. Examples of the alkylene glycol include ethylene glycol, propylene glycol, trimethylene glycol, 1,4-butanediol, 1,3-butanediol, 1,5-pentanediol, diethylene glycol, dipropylene glycol, triethylene glycol, tripropylene glycol, tetraethylene glycol, tetrapropylene glycol, and thiodiglycol. Examples of the polyalkylene glycol include polyethylene glycol and polypropylene glycol. The glycol compound is preferably diethylene glycol or triethylene glycol.

Examples of the lower alkyl group include a methyl group, an ethyl group, an n-propyl group, an i-propyl group, an n-butyl group, a tert-butyl group, a sec-butyl group, an i-butyl group, a straight chain or branched chain pentyl group, and a straight chain or branched chain hexyl group. The lower alkyl group is preferably an ethyl group or an n-butyl group.

Examples of the glycol ether include ethylene glycol monoalkyl ethers (specific examples include ethylene glycol monomethyl ether, ethylene glycol monoethyl ether, and ethylene glycol monobutyl ether), diethylene glycol monoalkyl ethers (specific examples include diethylene glycol monomethyl ether, diethylene glycol monoethyl ether, and diethylene glycol monobutyl ether), dipropylene glycol monoalkyl ethers (specific examples include dipropylene glycol monomethyl ether and dipropylene glycol monoethyl ether), triethylene glycol monoalkyl ethers (specific examples include triethylene glycol monomethyl ether and triethylene glycol monobuthyl ether), and tripropylene glycol monoalkyl ethers (specific examples include tripropylene glycol monomethyl ether). The glycol ether is preferably a diethylene glycol monoalkyl ether or a triethylene glycol monoalkyl ether, and more preferably diethylene glycol monoethyl ether or triethylene glycol monobutyl ether.

The content percentage of the glycol ether in the ink according to the present embodiment is at least 6.0% by mass and no greater than 40.0% by mass, preferably at least 6.0% by mass and no greater than 15.0% by mass, more preferably at least 8.0% by mass and no greater than 15.0% by mass, and further preferably at least 10.0% by mass and no greater than 15.0% by mass. As a result of the content percentage of the glycol ether being set to at least 6.0% by mass, an image formed with the ink according to the present embodiment can have increased scratch resistance. As a result of the content percentage of the glycol ether being set to no greater than 40.0% by mass, an environmental burden of the ink according to the present embodiment can be reduced.

The content percentage of the glycol ether is greater than the content percentage of the sugar alcohol in the ink according to the present embodiment. A difference between the content percentage of the glycol ether and the content percentage of the sugar alcohol is preferably at least 3.0% by mass and no greater than 10.0% by mass.

[Sugar Alcohol]

A sugar alcohol is a compound formed by reducing a carbonyl group of a sugar compound (for example, aldose or ketose). A sugar alcohol, which has multiple hydroxyl groups, is excellent in solubility in water. The sugar alcohol has a melting point of 25° C. or higher. Therefore, the sugar alcohol is in a solid state at normal temperature. The sugar alcohol preferably has a melting point of 50° C. or higher and 150° C. or lower.

Examples of the sugar alcohol include a straight chain sugar alcohol and a sugar alcohol having a ring structure. An example of the straight chain sugar alcohol is a compound obtained by substituting two or more of hydrogen atoms among hydrogen atoms of a straight chain alkane each with a hydroxyl group. The straight chain sugar alcohol is preferably a compound obtained by substituting 4 to 8 of hydrogen atoms among hydrogen atoms of a straight chain alkane having a carbon number of at least 4 and no greater than 8 each with a hydroxyl group. Specific examples of the straight chain sugar alcohol include sorbitol, mannitol, isitol, D-taritol, galactitol, allitol, xylitol, ribitol, arabitol, erythritol, threitol, volemitol, and perseitol. Examples of the sugar alcohol having a ring structure include isomalt and lactitol. The sugar alcohol is preferably a straight chain sugar alcohol, and more preferably sorbitol (melting point 95° C.) or xylitol (melting point 92° C.).

The content percentage of the sugar alcohol in the ink according to the present embodiment is at least 2.0% by mass and no greater than 10.0% by mass, and preferably at least 6.0% by mass and no greater than 10.0% by mass. As a result of the content percentage of the sugar alcohol being set to at least 2.0% by mass, an image formed with the ink according to the present embodiment can have increased scratch resistance. As a result of the content percentage of the sugar alcohol being no greater than 10.0% by mass, precipitation of the sugar alcohol in a recording head can be inhibited, with a result that occurrence of nozzle clogging can be inhibited.

[Water]

A content percentage of the water in the ink according to the present embodiment is for example at least 30.0% by mass and no greater than 60.0% by mass.

[Moisturizing Agent]

Preferably, the ink according to the present embodiment further contains a moisturizing agent. As a result of the ink according to the present embodiment containing a moisturizing agent, occurrence of nozzle clogging can be further effectively inhibited.

An example of the moisturizing agent is a glycol compound. Example of the glycol compound include the glycol compounds exemplified in description of the glycol ether. The moisturizing agent is preferably an alkylene glycol, and more preferably propylene glycol.

In a configuration in which the ink according to the present embodiment contains a moisturizing agent, a content percentage of the moisturizing agent contained in the ink is preferably at least 5.0% by mass and no greater than 30.0% by mass, and more preferably at least 10.0% by mass and no greater than 20.0% by mass. As a result of the content percentage of the moisturizing agent being set to at least 5.0% by mass and no greater than 30.0% by mass, occurrence of nozzle clogging can be further effectively inhibited.

[Surfactant]

The ink according to the present embodiment may further contain a surfactant. An example of the surfactant is a nonionic surfactant.

[Leveling Agent]

Preferably, the ink according to the present embodiment contains a leveling agent. An example of the leveling agent is an amphipathic oligomer. In a configuration in which the ink according to the present embodiment contains a leveling agent, a content percentage of the leveling agent is preferably at least 0.1% by mass and no greater than 1.0% by mass.

[Additional Components]

The ink according to the present embodiment may further contain a known additive (specific examples include a solution stabilizer, an anti-drying agent, an antioxidant, a viscosity modifier, a pH adjuster, and an antifungal agent) as necessary. Preferably, the ink according to the present embodiment further contains an anti-drying agent.

The solution stabilizer is compatible with each component contained in the ink according to the present embodiment to stabilize a solution state of the ink. Examples of the solution stabilizer include 2-pyrrolidone, N-methyl-2-pyrrolidone, and γ-butyrolactone.

The anti-drying agent is preferably glycerin. In a configuration in which the ink according to the present embodiment contains an anti-drying agent, a content percentage of the anti-drying agent in the ink is preferably at least 0.5% by mass and no greater than 10.0% by mass, and more preferably at least 1.5% by mass and no greater than 5.0% by mass.

It is preferable that the ink according to the present embodiment contains no resin or contains a resin in an amount of greater than 0.0% by mass and no greater than 5.0% by mass, and more preferably contains a resin in an amount of greater than 0.0% by mass and no greater than 1.0% by mass. When an ink according to the present embodiment contains no resin or contains a resin in an amount of greater than 0.0% by mass and no greater than 5.0% by mass, the ink can be favorably ejected, thereby further effectively inhibiting occurrence of nozzle clogging.

[Ink Production Method]

The ink according to the present embodiment can be produced by uniformly mixing a glycol ether, a sugar alcohol, water, a pigment dispersion containing pigment particles, and an additional component optionally blended as necessary using a stirrer. In production of the ink according to the present embodiment, foreign matter and coarse particles may be removed using a filter (for example, a filter having a pore size of no greater than 5 μm) after uniform mixing of each component.

(Pigment Dispersion)

The pigment dispersion is a dispersion containing the pigment particles. A solvent of the pigment dispersion is preferably water. The pigment dispersion preferably contains a resin in order to increase dispersibility of the pigment particles.

The pigment particles in the pigment dispersion have a Dso of preferably at least 50 nm and no greater than 200 nm, and more preferably at least 80 nm and no greater than 120 nm.

The content percentage of the pigment particles in the pigment dispersion is for example at least 5.0% by mass and no greater than 25.0% by mass. When the pigment dispersion contains a resin, a content percentage of the resin in the pigment dispersion is for example at least 2.0% by mass and no greater than 10.0% by mass.

When the pigment dispersion is added in production of the ink according to the present embodiment, a ratio of the pigment dispersion to all raw materials of the ink is for example at least 5.0% by mass and no greater than 20.0% by mass.

### Second Embodiment: Inkjet Recording System

An inkjet recording system according to a second embodiment will be described next. The inkjet recording system according to the present embodiment includes a recording head and a conveyance section that conveys a recording medium. The recording head ejects the ink according to the first embodiment toward the recording medium. The inkjet recording system according to the present embodiment does not include a post-processing section that dries the recording medium toward which the inkjet ink has been ejected. The following describes the inkjet recording system according to the present embodiment in detail with reference to the drawing. Note that the drawing referenced herein is a schematic illustration that emphasizes elements of configuration in order to facilitate understanding. Therefore, aspects such as size, number, and the like of each element of configuration illustrated in the drawing may differ from actual aspects thereof in order to aid preparation of the drawing.

FIGURE is a side view of a configuration of an inkjet recording system 100 that is an example of the inkjet recording system according to the present embodiment.

As illustrated in FIGURE, the inkjet recording system 100 includes, as main elements, a sheet feed tray 1, a sheet feed section 2, a conveyance section 3, an ejection section 4, an exit tray 5, and a plurality of recording heads 11. The sheet feed tray 1, the sheet feed section 2, the conveyance section 3, the ejection section 4, and the exit tray 5 are arranged in the stated order from upstream to downstream in terms of a conveyance direction X of a recording medium, which is a later-described recording sheet P (also referred to below simply as a conveyance direction X).

The sheet feed tray 1 accommodates thereon recording sheets P in a stacked manner. The sheet feed section 2 is disposed at a location adjacent to the sheet feed tray 1. The sheet feed section 2 includes a first sheet feed roller 2a and a second sheet feed roller 2b that are disposed opposite to each other. The first sheet feed roller 2a and the second sheet feed roller 2b are in contact with and pressed against each other. One of the first and second sheet feed rollers 2a and 2b is a rotation drive roller while the other thereof is a rotation drive roller or a driven roller. The sheet feed section 2 sequentially feeds the recording sheets P accommodated and stacked on the sheet feed tray 1 to the conveyance section 3 one at a time by rotation of the first and second sheet feed rollers 2a and 2b.

The conveyance section 3 includes a first belt roller 3a, a second belt roller 3b, and a conveyor belt 3c. The first and second belt rollers 3a and 3b are disposed on an upstream side and a downstream side in terms of the conveyance direction X, respectively, so as to be spaced apart from each other. The conveyor belt 3c is an endless belt wound around the first belt roller 3a and the second belt roller 3b. One of the first and second belt rollers 3a and 3b is a rotation drive roller while the other thereof is a rotation drive roller or a driven roller. The conveyance section 3 conveys the recording sheet P supplied onto the conveyor belt 3c in the conveyance direction X by rotation of the first and second belt rollers 3a and 3b.

The recording heads 11 are arranged above the conveyor belt 3c. The recording heads 11 include a first recording head 11C, a second recording head 11M, a third recording head 11Y, and a fourth recording head 11K. The first to fourth recording heads 11C to 11K are arranged side by side in the stated order in terms of the conveyance direction X. The first to fourth recording heads 11C to 11K are arranged at the same level height as each other. The first to fourth recording heads 11C to 11K are filled with inks in four different colors (cyan, magenta, yellow, and black). At least one ink of the four inks filled in the first to fourth recording heads 11C to 11K is the ink according to the first embodiment. Preferably, each of the four inks filled in the first to fourth recording heads 11C to 11K is the ink according to the first embodiment. The first to fourth recording heads 11C to 11K eject the respective inks from their nozzles to form an image (for example, a color image) on the recording sheet P conveyed by the conveyor belt 3c.

The ejection section 4 includes a first ejection roller 4a and a second ejection roller 4b that are disposed opposite to each other. The first ejection roller 4a and the second ejection roller 4b are in contact with and pressed against each other. One of the first and second ejection rollers 4a and 4b is a rotation drive roller while the other thereof is a rotation drive roller or a driven roller. The ejection section 4 ejects the recording sheet P conveyed by the conveyance section 3 onto the exit tray 5 by rotation of the first and second ejection rollers 4a and 4b. The exit tray 5 receives the ejected recording sheet P thereon.

As illustrated in FIGURE, the inkjet recording system 100 does not include a post-processing section that dries the recording sheet P toward which the ink has been ejected (specific examples include a heat treatment section or an ultraviolet irradiator). That is, the inkjet recording system 100 ejects the recording sheet P after image formation onto the exit tray 5 without performing drying. The inkjet recording system 100, which does not include a post-processing section that is a high-energy consumption member, provides high energy saving. The inkjet recording system 100, which does not include such a post-processing section though, uses the ink according to the present embodiment as an ink, and therefore, is capable of forming images having scratch resistance of a sufficient degree.

The inkjet recording system 100 that is an example of the inkjet recording system according to the present embodiment has been described so far with reference to the drawing. However, the inkjet recording system according to the present embodiment is not limited to the inkjet recording system 100. For example, the inkjet recording system according to the present embodiment may include one, two, three, five, or more recording heads. The inkjet recording system according to the present embodiment may be a multifunction peripheral. Furthermore, the recording medium used in the inkjet recording system according to the present embodiment may be made from any material other than the recording paper (for example, cloth).

### EXAMPLES

Hereinafter, examples of the present disclosure will be described. However, the present disclosure is in no way limited to the following examples. Raw materials used for producing inks will be described first.

[Pigment Dispersion]
Pigment dispersion (P-A): “KM-AB-K156”, product of Kao Corporation, pigment dispersion containing carbon black as a pigment (concentration: 14% by mass) and resin (concentration: 6% by mass)
Pigment dispersion (P-B): “KM-AB-K153”, product of Kao Corporation, pigment dispersion containing carbon black as a pigment (concentration: 15% by mass), resin (concentration: 4% by mass), and glycerin (concentration: 5% by mass)
Pigment dispersion (P-C): “KM-AC-112”, product of Kao Corporation, pigment dispersion containing Pigment Blue 15:3 as a pigment (concentration: 15% by mass), resin (7% by mass), and glycerin (5% by mass).

[Leveling Agent]

As a leveling agent, “POLYFLOW KL-870” produced by Kyoeisha Chemical Co., Ltd. was used. POLYFLOW KL-870 contained an amphipathic oligomer and an acrylic resin.

<Ink Production>

Inks (A-1) to (A-9) and (B-1) to (B-7) were produced according to the following methods.

[Ink (A-1)]

Ion exchanged water was added into a beaker to which a stirrer (“THREE-ONE MOTOR (registered Japanese trademark) L-600”, product of Shinto Scientific Co., Ltd.) had been attached. The beaker was charged with the pigment dispersion (P-1), the leveling agent, triethylene glycol monobutyl ether as a glycol ether, sorbitol as a sugar alcohol, glycerin as an anti-drying agent, and propylene glycol as a penetrating agent in the stated order under stirring of the content(s) of the beaker by the stirrer (stirring speed: 400 rpm). A ratio of the amounts of these raw materials was set as shown in Table 1 below. Through the above processes, an ink (A-1) was produced.

[Inks (A-2) to (A-9) and (B-1) to (B-7)]

Inks (A-2) to (A-9) and (B-1) to (B-7) were produced according to the same method as the method for producing the ink (A-1) in all aspects other than the following changes. In production of each of the inks (A-2) to (A-9) and (B-1) to (B-7), a ratio of the amounts of the respective raw materials was set as shown in Tables 1 and 2 below. Note that “C.B.” and “P.B.” in a row titled “Pigment” in each of Tables 1 and 2 indicate carbon black and Pigment Blue 15:3, respectively. “Mass %” for each component indicates a content percentage of a corresponding component in a corresponding ink. Note that the amount of the ion exchanged water corresponds to a remaining amount obtained by subtracting each amount of the other components (specifically, the pigment dispersion, the leveling agent, the glycol ether, the sugar alcohol, the anti-drying agent, and the penetrating agent) from the total amount (100% by mass) of the raw materials in the ink. For example, the amount of the ion exchanged water in the ink (A-1) is 53.6% by mass.

TABLE 1

| | | | Ink | | | | | | | | |
|---|---|---|---|---|---|---|---|---|---|---|---|
| | | | A-1 | A-2 | A-3 | A-4 | A-5 | A-6 | A-7 | A-8 | A-9 |
| Pigment dispersion | | Type | P-A | P-A | P-B | P-A | P-A | P-A | P-A | P-C | P-C |
| | | Mass % | 10.0 | 10.0 | 10.0 | 10.0 | 10.0 | 10.0 | 10.0 | 5.0 | 5.0 |
| | | Pigment | C.B. | C.B. | C.B. | C.B. | C.B. | C.B. | C.B. | P.B. | P.B. |
| Leveling agent | | Mass % | 0.4 | 0.4 | 0.4 | 0.4 | 0.4 | 0.4 | 0.4 | 0.4 | 0.4 |
| Glycol ether | Tiethylene glycol monobutyl ether | Mass % | 12.0 | 12.0 | 12.0 | 8.0 | 0.0 | 12.0 | 8.0 | 12.0 | 8.0 |
| | Diethylene glycol monoethyl ether | Mass % | 0.0 | 0.0 | 0.0 | 0.0 | 12.0 | 0.0 | 0.0 | 0.0 | 0.0 |
| Sugar alcohol | Sorbitol | Mass % | 8.0 | 3.0 | 8.0 | 3.0 | 3.0 | 0.0 | 0.0 | 8.0 | 3.0 |
| | Xylitol | Mass % | 0.0 | 0.0 | 0.0 | 0.0 | 0.0 | 8.0 | 3.0 | 0.0 | 0.0 |
| Anti-drying agent | Glycerin | Mass % | 3.0 | 3.0 | 3.0 | 3.0 | 3.0 | 3.0 | 3.0 | 3.0 | 3.0 |
| Penetrating agent | Propylene glycol | Mass % | 13.0 | 18.0 | 13.0 | 22.0 | 18.0 | 13.0 | 22.0 | 13.0 | 22.0 |

TABLE 2

| | | | Ink | | | | | | |
|---|---|---|---|---|---|---|---|---|---|
| | | | B-1 | B-2 | B-3 | B-4 | B-5 | B-6 | B-7 |
| Pigment dispersion | | Type | P-B | P-B | P-B | P-A | P-B | P-A | P-C |
| | | Mass % | 10.0 | 10.0 | 10.0 | 10.0 | 10.0 | 10.0 | 5.0 |
| | | Pigment | C.B. | C.B. | C.B. | C.B. | C.B. | C.B. | P.B. |
| Leveling agent | | Mass % | 0.4 | 0.4 | 0.4 | 0.4 | 0.4 | 0.4 | 0.4 |
| Glycol ether | Tiethylene glycol monobutyl ether | Mass % | 3.0 | 8.0 | 3.0 | 12.0 | 0.0 | 12.0 | 3.0 |
| | Diethylene glycol monoethyl ether | Mass % | 0.0 | 0.0 | 0.0 | 0.0 | 3.0 | 0.0 | 0.0 |
| Sugar alcohol | Sorbitol | Mass % | 1.0 | 12.0 | 8.0 | 1.0 | 3.0 | 0.0 | 3.0 |
| | Xylitol | Mass % | 0.0 | 0.0 | 0.0 | 0.0 | 0.0 | 0.0 | 0.0 |
| Anti-drying agent | Glycerin | Mass % | 3.0 | 3.0 | 3.0 | 3.0 | 3.0 | 11.0 | 3.0 |
| Penetrating agent | Propylene glycol | Mass % | 29.0 | 13.0 | 22.0 | 20.0 | 27.0 | 13.0 | 22.0 |

<Evaluation>

With respect to each of the inks (A-1) to (A-9) and (B-1) to (B-7), nozzle clogging and scratch resistance of a formed image were evaluated according to the following methods. Evaluation results are shown in Table 3 below. Note that the evaluation was carried out in an environment with a temperature of 25° C. and a relative humidity of 60%.

The following three types of recording paper were used in the evaluation. Each of the recording paper of the three types shown below was paper subjected to color lock treatment.
DNS: “DNS PREMIUM”, product of Mondi, basis weight 80 g/m²
Domtar: “DOMTAR (registered Japanese trademark) COPY”, product of Domtar Corporation, basis weight 75 g/m²
Vitality: “VITALITY”, product of Xerox Corporation, basis weight 75 g/m²

[Scratch Resistance]

An inkjet recording system (prototype produced by KYOCERA Document Solutions Inc.) was used as an evaluation apparatus. An ink that was an evaluation target (specifically any of the inks (A-1) to (A-9) and (B-1) to (B-7)) was set in a recording head of the evaluation apparatus. A solid image having a size of 4 cm by 5 cm was formed on recording paper (any of DNS, Domtar, and Vitality) using the evaluation apparatus (an image formation test). In the image formation test, the volume of each ink droplet ejected from the recording head was set to 12 pL.

[Scratch Resistance after 30 Seconds]

After 30 seconds from the image formation test, non-printed recording paper (recording paper of the same bland as that of the recording paper used in the image formation test) was placed on the surface of the recording paper on which the solid image had been formed (surface on a side with the solid image formed thereon). Next, a rectangular parallelepiped weight (mass 1 kg) having a bottom of which dimension was 4 cm by 5 cm was placed on the non-printed recording paper. The weight was placed at a location on the non-printed recording paper directly above the solid image. Next, the non-printed recording paper was moved horizontally with the opposite ends of the non-printed paper held. In the horizontal movement, the weight was moved over the solid image back and forth five times. Through the above movement, the solid image was scratched with the non-printed paper with a load of 1 kg applied. Thereafter, an image density of an area of the non-printed paper that had come in contact with the solid image was measured using an automatic scanning spectrophotometer (“FD-9”, product of KONICA MINOLTA JAPAN, INC.). Note that a visual density was measured in image density measurement of an image formed with each ink containing carbon black as a pigment. Also, a cyan density was measured in image density measurement of an image formed with each ink containing Pigment Blue 15:3 as a pigment. In addition, an image density of an area of the non-printed paper that had not come in contact with the solid image was used as a background value in the image density measurement. Scratch resistance was evaluated in accordance with the following criteria.

Particularly excellent (A): image density of 0.02 or less

Excellent (B): image density of greater than 0.02 and no greater than 0.04

Poor (C): image density of greater than 0.04

[Scratch Resistance after 24 Hours]

Scratch resistance of solid images was evaluated according to the same method as that for evaluation of scratch resistance after 30 seconds as described above in all aspects other than that evaluation was carried out after 24 hours had elapsed from the image formation test.

With respect to each ink, when all images formed on the respective three types of recording paper were evaluated as excellent or particularly excellent in both scratch resistance after 30 seconds and scratch resistance after 24 hours, scratch resistance of a to-be-formed image was evaluated as excellent.

[Nozzle Clogging]

Each solid image formed in the above-described image formation test was visually observed. With respect to each ink, the ink was evaluated as not being capable of sufficiently inhibiting occurrence of nozzle clogging (nozzle clogging: B) when a white line resulting from nozzle clogging was observed in any of the solid images formed on the three types of recording paper. By contrast, the ink was evaluated as being capable of inhibiting occurrence of nozzle clogging (nozzle clogging: A) when any white line resulting from nozzle clogging was not observed in any of the solid images formed on the respective three types of recording paper.

TABLE 3

| | Scratch resistance after 30 sec. | | | Scratch resistance after 24 hours | | | Nozzle |
|---|---|---|---|---|---|---|---|
| Ink | DNS | Domtar | Vitality | DNS | Domtar | Vitality | clogging |
| A-1 | A | A | A | A | A | A | A |
| A-2 | A | A | A | A | B | A | A |
| A-3 | A | B | B | A | B | B | A |
| A-4 | A | B | B | A | A | A | A |
| A-5 | A | B | B | A | B | B | A |
| A-6 | A | A | A | A | A | A | A |
| A-7 | A | B | B | A | B | B | A |
| A-8 | A | A | A | A | A | A | A |
| A-9 | A | A | A | A | A | A | A |
| B-1 | C | C | C | B | C | C | A |
| B-2 | A | A | B | A | A | A | B |
| B-3 | C | C | C | B | C | C | B |
| B-4 | A | C | C | A | B | B | A |
| B-5 | C | C | C | B | C | C | A |
| B-6 | C | C | C | A | A | A | A |
| B-7 | A | C | C | A | B | B | A |

Each of the inks (A-1) to (A-9) contained pigment particles, a glycol ether, a sugar alcohol, and water. The sugar alcohol had a melting point of 25° C. or higher. In each of the inks (A-1) to (A-9), the content percentage of the glycol ether was at least 6.0% by mass and no greater than 40.0% by mass. In each of the inks (A-1) to (A-9), the content percentage of the sugar alcohol was at least 2.0% by mass and no greater than 10.0% by mass. In each of the inks (A-1) to (A-9), the content percentage of the glycol ether was greater than the content percentage of the sugar alcohol. Each of the inks (A-1) to (A-9) inhibited occurrence of nozzle clogging and an image formed with the ink had excellent scratch resistance.

By contrast, the inks (B-1) to (B-7) each did not have the above features. Accordingly, the ink caused nozzle clogging or an image formed with the ink had poor scratch resistance.

Specifically, the ink (B-1) had a content percentage of the glycol ether of less than 6.0% by mass and a content percentage of the sugar alcohol of less than 2% by mass. As a result, an image formed with the ink (B-1) had poor scratch resistance.

In the ink (B-2), the content percentage of the glycol ether was less than the content percentage of the sugar alcohol and the content percentage of the sugar alcohol was greater than 10.0% by mass. As a result, the ink (B-2) did not inhibit occurrence of nozzle clogging.

In the ink (B-3), the content percentage of the glycol ether was less than 6.0% by mass and less than the content percentage of the sugar alcohol. As a result, an image formed with the ink (B-3) had poor scratch resistance and the ink did not inhibit nozzle clogging.

The ink (B-4) had a content percentage of the sugar alcohol of less than 2.0% by mass. As a result, an image formed with the ink (B-4) had poor scratch resistance.

In each of the inks (B-5) and (B-7), the content percentage of the glycol ether was less than 6.0% by mass and equal to the content percentage of the sugar alcohol. As a result, an image formed with either the inks (B-5) or the ink (B-7) had poor scratch resistance.

The ink (B-6) contained no sugar alcohol. As a result, an image formed with the ink (B-6) had poor scratch resistance.

What is claimed is:

1. An inkjet ink comprising:
pigment particles, a glycol ether, a sugar alcohol, and water, wherein
the sugar alcohol has a melting point of 25° C. or higher,
a content percentage of the glycol ether is at least 6.0% by mass and no greater than 40.0% by mass,
a content percentage of the sugar alcohol is at least 2.0% by mass and no greater than 10.0% by mass, and
the content percentage of the glycol ether is greater than the content percentage of the sugar alcohol.

2. The inkjet ink according to claim 1, wherein
the sugar alcohol includes a straight chain sugar alcohol.

3. The inkjet ink according to claim 2, wherein
the sugar alcohol includes sorbitol or xylitol.

4. The inkjet ink according to claim 1, wherein
the glycol ether includes a diethylene glycol monoalkyl ether or a triethylene glycol monoalkyl ether.

5. The inkjet ink according to claim 4, wherein
the glycol ether includes diethylene glycol monoethyl ether or triethylene glycol monobutyl ether.

6. The inkjet ink according to claim 1, wherein
the content percentage of the glycol ether is at least 6.0% by mass and no greater than 15.0% by mass,

7. An inkjet recording system comprising:
a conveyance section configured to convey a recording medium; and
a recording head, wherein
the recording head ejects the inkjet ink according to claim 1 toward the recording medium, and
the inkjet recording system does not include a post-processing section configured to dry the recording medium toward which the inkjet ink has been ejected.
